(19) United States
(12) Patent Application Publication
(10) Pub. No.: US 2006/0146665 A1
(43) Pub. Date: Jul. 6, 2006

(54) Apparatus and method for generating modulation signal using tangential push-pull signal

(76) Inventors: Jun-ho Huh, Yongin-si (KR); Yong-chun Kim, Yongin-si (KR)

Correspondence Address: HARNESS, DICKEY & PIERCE, P.L.C., P.O. BOX 8910, RESTON, VA, 20195, US

(21) Appl. No.: 11/320,895

(22) Filed: Dec. 30, 2005

(30) Foreign Application Priority Data
Dec. 31, 2004 (KR) 10-2004-117936

(51) Int. Cl. G11B 7/00

(52) U.S. Cl. 369/44.28; 369/44.41

(57) ABSTRACT

An apparatus and a method for generating a modulation signal, for example, an eight-to-fourteen modulation (EFM) signal using a tangential push-pull (TPP) signal. The apparatus may include a TPP peak detector detecting peaks of the TPP signal; and a signal generator generating the modulation signal by determining the detected peaks of the TPP signal as edges of the modulation signal. The apparatus may determine peaks of a TPP signal as edges of a modulation signal to generate the modulation signal, thereby reducing or minimizing timing jitter caused by an asymmetry of marks or pits.

### PRIORITY STATEMENT

This application claims the benefit of Korean Patent Application No. 10-2004-0117936, filed on Dec. 31, 2004, in the Korean Intellectual Property Office, the disclosure of which is hereby incorporated by reference in its entirety.

### BACKGROUND OF THE INVENTION

1. Field of the Invention

Example embodiments of the present invention relate to an apparatus and method for reproducing from a digital medium, for example, an optical disc, and more particularly, to an apparatus and method for reproducing from a digital medium, for example, an optical disc which may restore a modulation signal without timing jitter by finding rising and falling edges of the modulation signal using a tangential push-pull (TPP) signal.

2. Description of the Related Art

An optical disc recording reproduction unit may reproduce information by restoring an eight-to-fourteen modulation (EFM) signal from an optical disc. To be more specific, the optical disc recording reproduction unit may restore the EFM signal by projecting light on the optical disc, detecting reflected light using a light detector, for example, photo diodes (PD), and sum the amount of the detected light.

The EFM signal may be recorded on a track of the optical disc in pits or marks. Pits are recessed areas in a depth direction of a substrate of the optical disc and marks, which have a reflectance different from that of the substrate, are raised areas on the substrate.

Light reflected off the marks of the track is less than that reflected off non-mark regions. Similarly, light reflected off pits of the track is less than that reflected off non-pit regions. Therefore, non-mark or non-pit regions reflect a greater amount of light than marks or pits.

An apparatus for generating an EFM signal may project light on an optical disc and measure the amount of light reflected off pits or marks to restore the EFM signal.

FIG. 1 is a block diagram illustrating a conventional apparatus for generating an EFM signal. The apparatus 100 may comprise a light detector 110, a total sum operator 120, an auto gain controller (AGC) 130, an equalizer (EQ) 140, and/or a slicer 150.

The light detector 110 may receive light (not shown) which is reflected off a track of an optical disc. The light detector 110 may include four fields A, B, C, and D which may be grouped into two fields AB and CD in a track forward direction and two fields AC and BD in a vertical direction (a radius direction of the optical disc) of the track forward direction.

The light detector 110 may detect light reflected off the track as the optical disc rotates. The total sum operator 120 may sum the light detected in the light detector 110 and output the summed light as a total sum signal ABCD_SUM, which may be an RF signal.

The total sum signal ABCD_SUM may be used to control and correct a gain in the AGC 130 according to a frequency and maintain a bandwidth delay in the EQ 140. The slicer 150 may slice the total sum signal ABCD_SUM in which the gain is controlled and an error is corrected to a desired slice level to generate an EFM signal.

FIG. 2 is a graph illustrating the relationship between the track and each signal in the apparatus for generating the EFM signal shown in FIG. 1. Referring to FIG. 2, the total sum signal ABCD_SUM has a relatively small value at marks and a relatively large value at regions other than marks. The total sum signal ABCD_SUM may be sliced to a desired slice level to generate the EFM signal.

However, pits or marks indicated on an optical disc are usually asymmetric, due to manufacturing or recording operations of the optical disc. Such an asymmetry may result in the generation of timing jitter in the EFM signal used to restore data.

When a pit is recorded on the optical disc, if the pit has a shorter length, for example, 3T, the pit may not be long enough to discriminate signals reflected off the pit. When spaces between pits are shorter, such spaces may not be long enough to discriminate signals reflected off the spaces.

Therefore, when light is reflected off pits having a shorter length, the reflected light may not be reduced enough to discriminate reflected signals. When light is reflected off spaces between the pits having a shorter length, the amount of the reflected light may not be enough to discriminate reflected signals.

When light is reflected off marks recorded on the optical disc having a shorter length, the reflected light may not be reduced enough to discriminate reflected signals. When light is reflected off spaces between the marks having a shorter length, the amount of the reflected light may not be enough to discriminate reflected signals. As shown in FIG. 2, when generating the EFM signal by slicing the total sum signal ABCD_SUM with a desired slice level, timing jitter (a), (b), (c), and/or (d) may be created.

To be more specific, the amount of the reflected light may not be enough to discriminate signals at the spaces between the marks having the shorter length, causing timing jitter (a) and (b). The reflected light may not be reduced enough to discriminate signals at the marks having the shorter length, causing timing jitter (c) and (d).

To reduce such timing jitter, the conventional apparatus 100 for generating the EFM signal includes the AGC 130 and the EQ 140 shown in FIG. 1. However, the AGC 130 and the EQ 140 may increase circuit area and/or power consumption.

### SUMMARY OF THE INVENTION

Example embodiments of the present invention provide an apparatus for generating a modulation signal, for example, an eight to fourteen modulation (EFM) signal that does not cause timing jitter due to asymmetry by finding rising and falling edges of the modulation signal.

Example embodiments of the present invention provide an apparatus for generating a modulation signal, for example, an eight to fourteen modulation (EFM) signal that does not cause timing jitter due to asymmetry by finding rising and falling edges of the modulation signal, using a tangential push-pull (TPP) signal.

Example embodiments of the present invention provide a method of generating a modulation signal, for example, an EFM signal, that does not cause timing jitter due to asymmetry by finding rising and falling edges of the modulation signal.

Example embodiments of the present invention provide a method of generating a modulation signal, for example, an EFM signal, that does not cause timing jitter due to asymmetry by finding rising and falling edges of the modulation signal, using a TPP signal.

According to an example embodiment of the present invention, there is provided an apparatus for generating a modulation signal in response to a tangential push-pull (TPP) signal generated by light reflected from an optical disc, the apparatus including a TPP peak detector detecting peaks of the TPP signal and a signal generator generating the modulation signal by determining the detected peaks of the TPP signal as edges of the modulation signal.

According to an example embodiment of the present invention, the apparatus further includes an analogue-digital converter converting the TPP signal into a digital TPP signal.

According to an example embodiment of the present invention, the apparatus further includes a delay unit delaying the TPP signal, the TPP peak determiner determining peaks of the TPP signal in response to the difference between the delayed TPP signal and the TPP signal.

According to an example embodiment of the present invention, the apparatus further includes a delayed locked loop (DLL) generating a plurality of clock signals having a given phase difference, the TPP peak determiner sequentially sampling TPP signals in response to the plurality of clock signals and determining peaks of the TPP signal in response to differences between the sequentially sampled TPP signals.

According to an example embodiment of the present invention, the modulation signal is an eight-to-fourteen modulation (EFM) signal and the signal generator is an EFM signal generator.

According to an example embodiment of the present invention, there is provided a method of generating a modulation signal in response to a TPP signal generated by light reflected from an optical disc, the method including detecting peaks of the TPP signal and generating the modulation signal by determining the detected peaks of the TPP signal as edges of the modulation signal.

According to an example embodiment of the present invention, detecting peaks of the TPP signal may include converting the TPP signal into a digital TPP signal and determining points where an increasing value of the converted TPP signal is changed to a decreasing value and the decreasing value is changed to the increasing value as peaks of the TPP signal in response to the converted TPP signal.

According to an example embodiment of the present invention, detecting peaks of the TPP signal may include delaying the TPP signal and determining peaks of the TPP signal in response to the difference between the delayed TPP signal and the TPP signal.

According to an example embodiment of the present invention, detecting peaks of the TPP signal may include generating a plurality of clock signals having a given phase difference, sequentially sampling TPP signals in response to the plurality of clock signals, and determining peaks of the TPP signal in response to differences between the sequentially sampled TPP signals.

According to an example embodiment of the present invention, the modulation signal is an eight-to-fourteen modulation (EFM) signal and the signal generator is an EFM signal generator.

### BRIEF DESCRIPTION OF THE DRAWINGS

The above and other aspects and advantages of example embodiments the present invention will become more apparent by describing in detail an exemplary embodiment thereof with reference to the attached drawings in which:

FIG. 1 is a block diagram illustrating a conventional apparatus for generating an eight-to-fourteen modulation (EFM) signal;

FIG. 2 is a graph of the relationship between a track and each signal of the apparatus for generating the EFM signal in FIG. 1;

FIG. 3 is a block diagram illustrating an apparatus for generating an EFM signal according to an example embodiment of the present invention;

FIG. 4 is an example graph of a track and a tangential push-pull (TPP) signal in a TPP signal generator shown in FIG. 3;

FIG. 5 is a block diagram illustrating the apparatus for generating an EFM signal according to another example embodiment of the present invention;

FIG. 6 is a block diagram illustrating an apparatus for generating an EFM signal according to another example embodiment of the present invention;

FIG. 7 is an example timing diagram illustrating the relationship between a track and each signal in the apparatus for generating the EFM signal shown in FIG. 5;

FIG. 8 is a block diagram illustrating an apparatus for generating an EFM signal according to another example embodiment of the present invention;

FIG. 9A is a block diagram illustrating an apparatus for generating an EFM signal according to another example embodiment of the present invention;

FIG. 9B is an example graph for comparing a TPP signal and a TPPD signal;

FIG. 10A is a block diagram illustrating an apparatus for generating an EFM signal according to another example embodiment of the present invention;

FIG. 10B is a block diagram illustrating a TPP peak determiner shown in FIG. 10A according to an example embodiment of the present invention;

FIG. 10C is an example timing diagram illustrating signals in the TPP peak determiner;

FIG. 11 is an example graph of variations in sum signals according to the length of marks in the TPP signal generator;

FIG. 12 is an example graph for comparing TPP signals and the sum signals according to the length of marks in the TPP signal generator;

FIG. 13 is a flowchart of a method of generating an EFM signal according to an example embodiment of the present invention;

FIG. 14 is a flowchart of a method of generating an EFM signal according to another example embodiment of the present invention;

FIG. 15 is a flowchart of a method of generating an EFM signal according to another example embodiment of the present invention;

FIG. 16 is a flowchart of a method of generating an EFM signal according to another example embodiment of the present invention.

### DETAILED DESCRIPTION OF EXAMPLE EMBODIMENTS OF THE INVENTION

The present invention will now be described more fully with reference to the accompanying drawings, in which example embodiments of the invention are shown. Throughout the drawings, like reference numerals refer to like elements.

Various example embodiments of the present invention will now be described more fully with reference to the accompanying drawings in which some example embodiments of the invention are shown. In the drawings, the thicknesses of layers and regions may be exaggerated for clarity.

Detailed illustrative embodiments of the present invention are disclosed herein. However, specific structural and functional details disclosed herein are merely representative for purposes of describing example embodiments of the present invention. This invention may, however, may be embodied in many alternate forms and should not be construed as limited to only the embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the invention to the particular forms disclosed, but on the contrary, example embodiments of the invention are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the scope of example embodiments of the present invention.

Spatially relative terms, such as “beneath”, “below”, “lower”, “above”, “upper” and the like, may be used herein for ease of description to describe one element or a feature's relationship to another element or feature as illustrated in the Figures. It will be understood that the spatially relative terms are intended to encompass different orientations of the device in use or operation in addition to the orientation depicted in the Figures. For example, if the device in the Figures is turned over, elements described as “below” or “beneath” other elements or features would then be oriented “above” the other elements or features. Thus, for example, the term “below” can encompass both an orientation which is above as well as below. The device may be otherwise oriented (rotated 90 degrees or viewed or referenced at other orientations) and the spatially relative descriptors used herein should be interpreted accordingly.

The terminology used herein is for the purpose of describing particular embodiments only and is not intended to be limiting of example embodiments of the invention. As used herein, the singular forms “a”, “an” and “the” are intended to include the plural forms as well, unless the context clearly indicates otherwise. It will be further understood that the terms “comprises,” “comprising,” “includes” and/or “including,” when used in this specification, specify the presence of stated features, integers, steps, operations, elements, and/or components, but do not preclude the presence or addition of one or more other features, integers, steps, operations, elements, components, and/or groups thereof.

Example embodiments of the present invention are described herein with reference to cross-sectional illustrations that are schematic illustrations of idealized embodiments (and intermediate structures). As such, variations from the shapes of the illustrations as a result, for example, of manufacturing techniques and/or tolerances, may be expected. Thus, example embodiments of the invention should not be construed as limited to the particular shapes of regions illustrated herein but may include deviations in shapes that result, for example, from manufacturing.

It should also be noted that in some alternative implementations, the functions/acts noted may occur out of the order noted in the FIGS. For example, two FIGS. shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments of the present invention belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In order to more specifically describe example embodiments of the present invention, various aspects of the present invention will be described in detail with reference to the attached drawings. However, the present invention is not limited to the example embodiments described. In the figures, if a layer is formed on another layer or a substrate, it means that the layer is directly formed on another layer or a substrate, or that a third layer is interposed therebetween. In the following description, the same reference numerals denote the same elements.

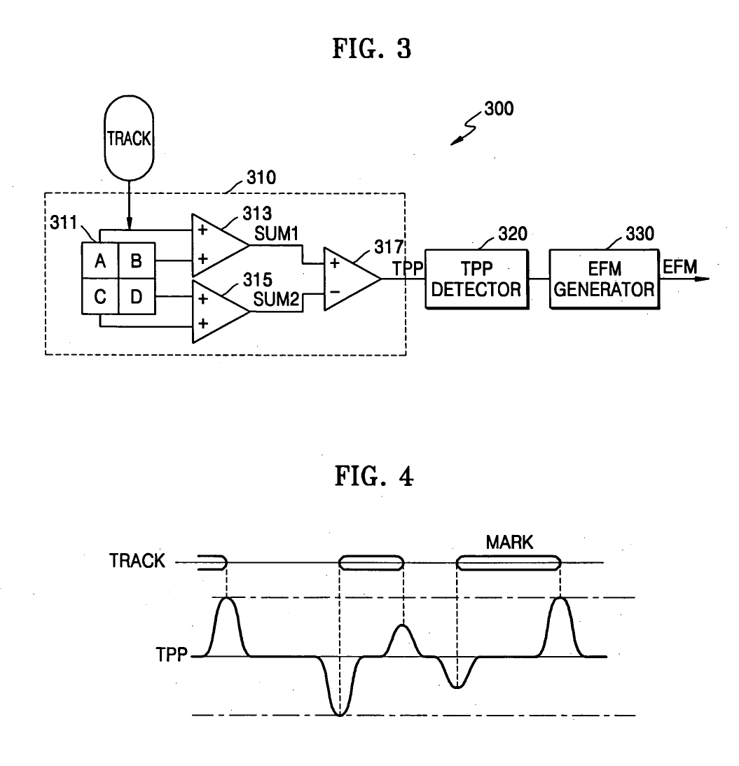

FIG. 3 is a block diagram illustrating an apparatus for generating a modulation signal, for example, an eight-to-fourteen modulation (EFM) signal according to an example embodiment of the present invention. Referring to FIG. 3, the apparatus 300 may include a tangential push-pull (TPP) signal generator 310, a TPP peak detector 320, and/or an EFM signal generator 330.

The TPP signal generator 310 may include a light detector 311, a first adder 313, a second adder 315, and/or a TPP signal generator 317.

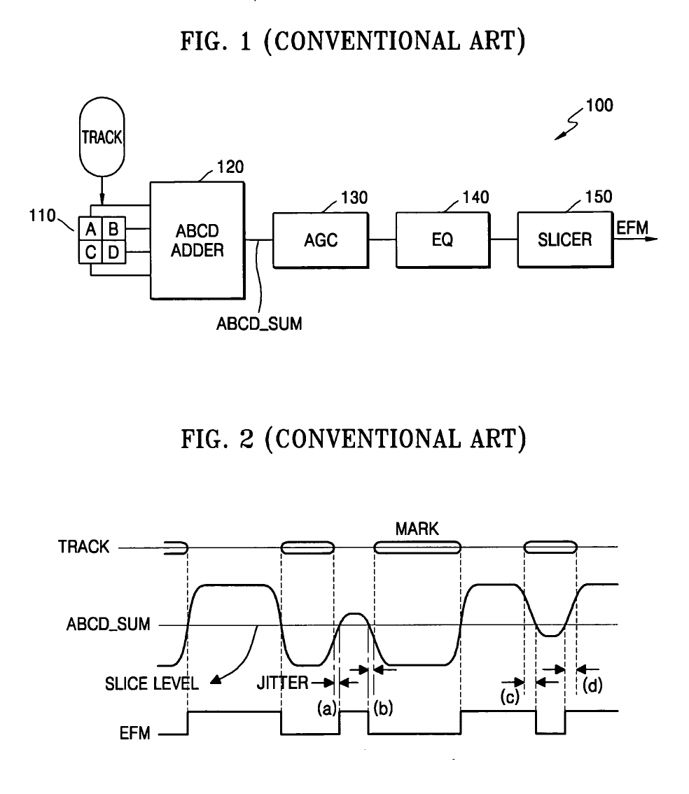

The optical detector 311 may be divided into four fields in the same manner as the light detector 110 used in the conventional apparatus 100 for generating the EFM signal shown in FIG. 1. An AB field may receive preceding reflected light to the track forward direction when an optical disc rotates. A CD field may receive following reflected light to the track forward direction.

The first adder 313 adds the preceding reflected light to the track forward direction, and is received in the AB field among the four fields of the light detector 311, and generates an RF signal, which is a first sum signal SUM1. The second adder 315 adds the following reflected light to the track forward direction and is received in the CD field, among the four fields of the light detector 311, and generates an RF signal, which is a second sum signal SUM2.

The TPP signal generator 317 may generate a TPP signal in response to the difference between the first sum signal and the second sum signal. The TPP signal may be generated in response to the difference between the amount (the first sum signal) of the preceding reflected light to the track forward direction and the amount (the second sum signal) of the following reflected light to the track forward direction when the optical disc rotates. The TPP signal may indicate the difference between the amounts of the reflected light in a tangential direction to which the optical disc rotates.

The TPP signal may have a rising peak at boundaries between marks and regions other than marks and a falling peak at boundaries between regions other than the marks and the marks.

Similarly, the TPP signal may have a rising peak at boundaries between pits and regions other than pits and a falling peak at boundaries between regions other than the pits and the pits.

The TPP peak detector 320 may detect the peaks of the TPP signal (in response to the TPP signal using the characteristics of the TPP signal) using the first and second sum signals, by converting the TPP signal into an analogue-digital signal, or in response to the difference between the TPP signal and a TPPD signal that delays the TPP signal.

FIG. 4 is a graph of an example track and an example TPP signal in the TPP signal generator shown in FIG. 3. Referring to FIG. 4, the peaks of the TPP signal, which may be an RF signal, correspond to mark boundaries and may be detected as edges of a modulation signal, for example, an EFM signal. Thus, the EFM signal may be generated with reduced or without timing jitter.

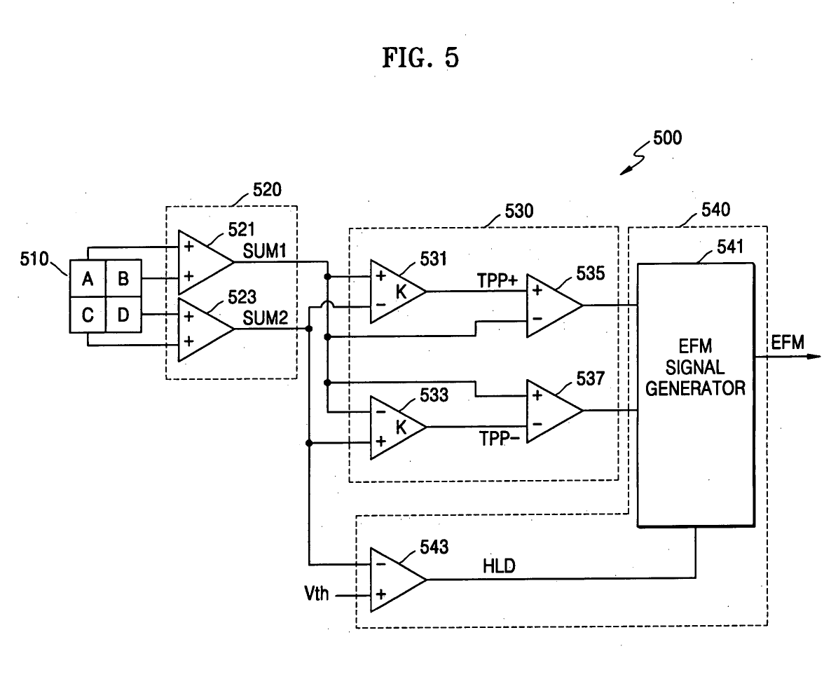

FIG. 5 is a block diagram illustrating an apparatus for generating a modulation signal, for example, an EFM signal, according to another example embodiment of the present invention. Referring to FIG. 5, the apparatus 500 may include a light detector 510, an adder 520, a TPP peak detector 530, and/or an EFM signal generator 540.

The light detector 510 may be divided into four fields in which an AB field receives preceding reflected light to the track forward direction when an optical disc rotates and a CD field receives reflected light that moves backward the track when the optical disc rotates.

The first adder 520 adds the preceding reflected light to the track forward direction and is received in the AB field among the four fields of the light detector 510 and generates an RF signal, which is a first sum signal SUM1. The second adder 530 adds the following reflected light to the track forward direction and is received in the CD field among the four fields of the light detector 510 and generates an RF signal, which is a second sum signal SUM2.

The TPP peak detector 530 may generate a TPP signal in response to the first sum signal SUM1 and the second sum signal SUM2 and detect peaks of the TPP signal. The TPP peak detector 530 may include first peak detectors 531 and 535 and second peak detectors 533 and 537.

The first peak detectors 531 and 535 may include a first TPP signal generator 531 and a first peak determiner 535. The first TPP signal generator 531 may generate a first TPP signal TPP+ in response to the difference between the first sum signal SUM1 and the second sum signal SUM2. The first TPP signal TPP+ may be identical to a TPP signal.

The first peak determiner 535 may determine a first peak of the TPP signal in response to a difference between the first TPP signal TPP+ and the first sum signal SUM1.

The second peak detectors 533 and 537 may include a second TPP signal generator 533 and a second peak determiner 537. The second TPP signal generator 533 may generate a second TPP signal TPP− in response to the difference between the second sum signal SUM2 and the first sum signal SUM1.

The second TPP signal TPP− may have a phase difference of 1800 with respect to the first TPP signal TPP+ and may be generated by the second TPP signal generator 533 by inverting the first TPP signal TPP+, which may be the same as the TPP signal.

The second peak determiner 535 may determine a second peak of the TPP signal in response to a difference between the second TPP signal TPP− and the first sum signal SUM1.

The first and second TPP signal generators 531 and 533 may adjust gains of the first and second TPP signals TPP+ and TPP− according to a disc speed, thereby accurately detecting peaks of the TPP signal, suitable for the disc speed.

In example embodiments, the TPP peak detector 530 may comprise the TPP signal generators 531 and 533 and the TPP peal determiners 535 and 537.

The TPP signal generators 531 and 533 may generate a TPP signal in response to the first sum signal SUM1 and the second sum signal SUM2. The TPP signal generators 531 and 535 may include the first TPP signal generator 531 and the second TPP signal generator 533.

The first TPP signal generator 531 may generate the first TPP signal TPP+ in response to the first sum signal SUM1 and the second sum signal SUM2. The first TPP signal TPP+ may be identical to the TPP signal.

The second TPP signal generator 533 may generate the second TPP signal TPP− in response to the second sum signal SUM2 and the first sum signal SUM1. The second TPP signal TPP− may have a phase difference of 180° with respect to the first TPP signal TPP− and may be generated by the second TPP signal generator 533 by inverting the first TPP signal TPP+, which may be the same as the TPP signal.

The first and second TPP signal generators 531 and 533 may adjust gains of the first and second TPP signals TPP+ and TPP− according to the disc speed, thereby accurately detecting peaks of the TPP signal suitable for the disc speed.

The TPP peak determiners 535 and 537 may determine peaks of the TPP signal in response to each difference between the first and second TPP signals TPP+ and TPP− and the first sum signal SUM1. The TPP peak determiners 533 and 537 may include the first peak determiner 535 and the second peak determiner 537.

The first peak determiner 535 may determine the first peak of the TPP signal in response to a difference between the first TPP signal TPP+ and the first sum signal SUM1. The second peak determiner 537 may determine the second peak of the TPP signal in response to the difference between the second TPP signal TPP− and the first sum signal SUM1.

The EFM signal generator 540 may generate an EFM signal in response to the peaks of the TPP signal and the second sum signal SUM2. The EFM signal generator 540 may include a maintenance signal generator 543 and an EFM signal generator 541.

The maintenance signal generator 543 may generate a hold signal HLD for controlling a period when the EFM signal is maintained at desired level in response to the difference between the second sum signal SUM2 and a given reference voltage Vth. The hold signal HLD need not change edges of the EFM signal regarding the second sum signal SUM2 having a value less than that of the given reference voltage Vth.

In example embodiments, because the edges of the EFM signal are changed regarding the second sum signal SUM higher than a given level, the EFM signal may be stably generated.

The EFM signal generator 541 may generate the EFM signal in response to the peaks of the TPP signal and the hold signal HLD. The EFM signal generator 541 may determine the first and second peaks of the TPP signal as first and second edges of the EFM signal.

The EFM signal generator 541 may maintain the EFM signal at a first level after the first edge and at a second level after the second edge, in response to the hold signal HLD.

An apparatus for generating a modulation signal, for example, an EFM signal according to another example embodiment of the present invention may be realized by reversing the TPP signal TPP+ and generating the second TPP signal TPP−. An apparatus for generating the EFM signal according to another example embodiment of the present invention may be more easily realized using a conventional apparatus for generating the TPP signal.

An apparatus for generating an EFM signal according to another example embodiment of the present invention may include a TPP peak detector and an EFM signal generator. The TPP peak detector may include a TPP inverter, a first peak detector, and/or a second peak detector.

The TPP inverter may invert the TPP signal TPP+ and generates a TPP inversion signal TPP−. The construction of the first and second peak detectors and the EFM signal generator may be the same as that of the first and second peak detectors 535 and 537 and the EFM signal generator 540 shown in FIG. 5.

The apparatus 500 for generating the EFM signal according to an example embodiment of the present invention may detect the first peak of the TPP signal in response to a difference between the TPP signal TPP+ and the first sum signal SUM1 and the second peak of the TPP signal in response to the difference between the TPP inversion signal TPP− and the first sum signal SUM1 to generate the EFM signal.

The apparatus 500 may generate the EFM signal more accurately than the conventional apparatus 100, thereby improving readability of an optical disc device.

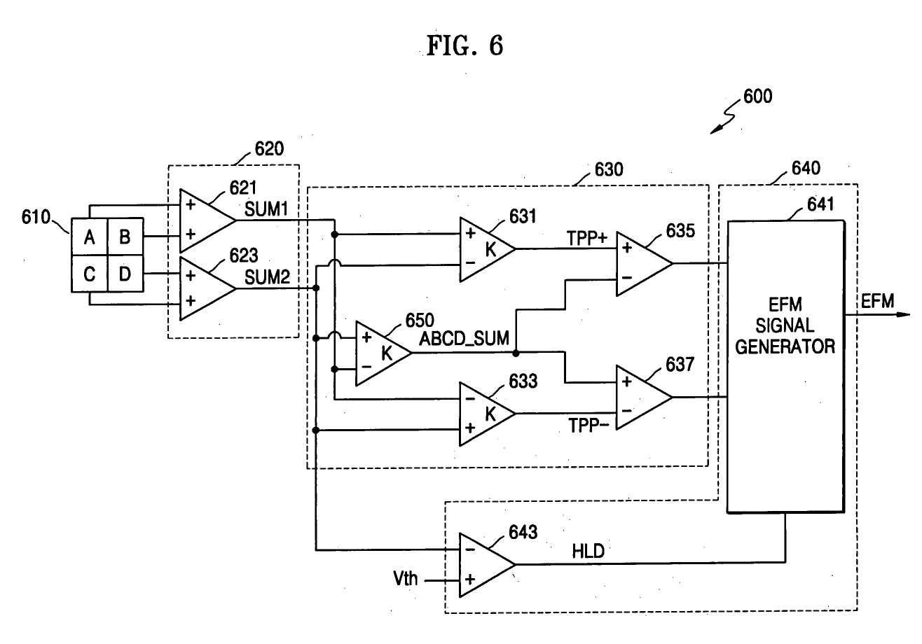

FIG. 6 is a block diagram illustrating an apparatus for generating an EFM signal according to another example embodiment of the present invention. Referring to FIG. 6, the apparatus 600 for generating the EFM signal may have the same construction as that of the apparatus 500 for generating the EFM signal shown in FIG. 5, except that first and second TPP peak detectors 635 and 637 may determine first and second peaks in response to a total sum signal ABCD_SUM, instead of a first sum signal SUM1.

The apparatus 600 for generating the EFM signal may further include a total sum adder 650 in addition to a light detector 610, an adder 620, a TPP peak detector 630, and/or an EFM signal generator 640.

The total sum adder 650 may sum first and second sum signals SUM1 and SUM2, adjust gains of the summed signals, and generate the total sum signal ABCD_SUM. The adjusted gain of the total sum adder 650 may be ½.

The first peak determiner 635 may determine a first peak of a TPP signal in response to the difference between a first TPP signal TPP+ and the total sum signal ABCD_SUM. The second peak determiner 637 may determine a second peak of the TPP signal in response to the difference between a second TPP signal TPP− and the total sum signal ABCD_SUM.

As described above, the apparatus 600 for generating the EFM signal may detect the first peak or the second peak of the TPP signal in response to the difference between the TPP signal TPP+ or the TPP inversion signal TPP− and the total sum signal ABCD_SUM that sums the reflected light received by the light detector 610.

The apparatus 600 for generating the EFM signal may improve detection of the peaks of the TPP signal, as compared with the case where the first peak or the second peak of the TPP signal is detected in response to the difference between the first sum signal SUM1 and the TPP signal TPP+ or the TPP inversion signal TPP−.

The operation of an apparatus for generating an EFM signal will be now described with reference to FIGS. 5 through 7.

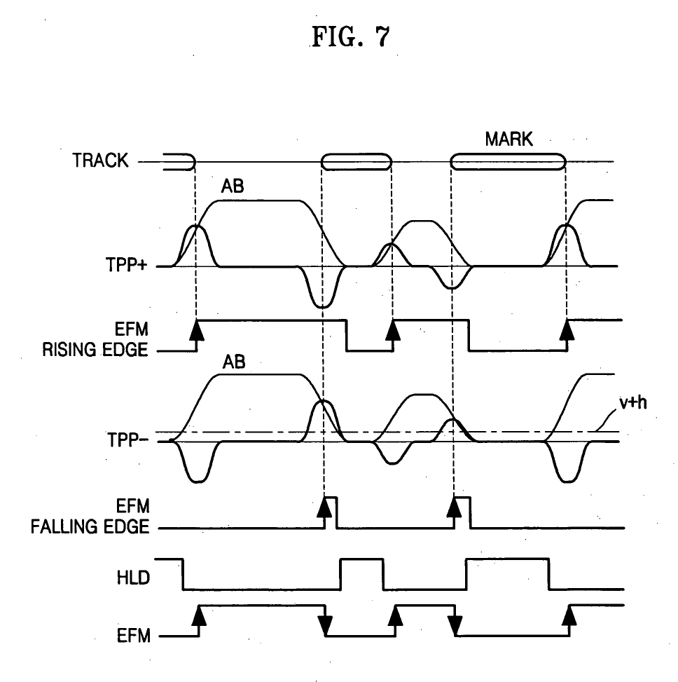

FIG. 7 is a timing diagram illustrating an example relationship between a track and each signal in the apparatus for generating the EFM signal shown in FIG. 5. Referring to FIG. 7, the track may be divided into marks and non-marks. The marks may have a reflectance lower than that of the non-marks. Therefore, the marks may have a smaller amount of light that is projected and reflected on an optical disc, than that of the non-marks.

In the first sum signal SUM1 overlapped with the first TPP signal TPP+ and the second TPP signal TPP−, the marks have a smaller amount of the reflected light than that of the non-marks.

In a timing diagram of the first TPP signal TPP+, a rising peak (a first peak) of the first TPP signal corresponds to boundaries between the marks and the non-marks.

In a timing diagram of the second TPP signal TPP−, a falling peak (a second peak) of the first TPP signal corresponds to boundaries between the non-marks and the marks.

An apparatus for generating an EFM signal may generate an EFM signal using boundaries between the marks and the non-marks and the relationship between the rising and falling peaks of the TPP signal.

In a timing diagram of the first TPP signal TPP+ and the first sum signal SUM1, a point where the first TPP signal TPP+ greater than the first sum signal SUM1 is changed to be smaller than the first sum signal SUM1 is the rising peak of the first TPP signal TPP+.

Therefore, the first peak determiner 535 may determine a point where the first TPP signal TPP+ greater than the first sum signal SUM1 is changed to be smaller than the first sum signal SUM1 as the first peak, which is the rising peak of the first TPP signal TPP+, in response to the difference between the first TPP signal TPP+ and the first sum signal SUM1.

The EFM signal generator 541 generates a logic low value when the first TPP signal TPP+ is greater than the first sum signal SUM1 and a logic high value when the first TPP signal TPP+ is smaller than the first sum signal SUM1 to generate a signal for detecting an EFM rising edge (the first edge).

In a timing diagram of the second TPP signal TPP− and the first sum signal SUM1, a point where the second TPP signal TPP− smaller than the first sum signal SUM1 is changed to be greater than the first sum signal SUM1 is the falling peak of the second TPP signal TPP−.

The second peak determiner 537 may determine a point where the second TPP signal TPP− smaller than the first sum signal SUM1 is changed to be greater than the first sum signal SUM1 is the second peak, which is the falling peak of the TPP signal, in response to the difference between the second TPP signal TPP− and the first sum signal SUM1.

The EFM signal generator 541 may generate a logic high value when the second TPP signal TPP− is greater than the first sum signal SUM1 and a logic low value when the second TPP signal TPP− is smaller than the first sum signal SUM1 to generate a signal for detecting an EFM falling edge (the second edge).

The hold signal generator 543 may generate the hold signal HLD to detect one or more edges of the EFM signal when the second sum signal SUM2 has a value greater than a given voltage level Vth in response to the difference between the given voltage level Vth and the second sum signal SUM2.

As shown in FIG. 7, the hold signal HLD may have a logic low value at locations where the rising and falling edges of the EFM signal are detected and a logic high value at locations where the rising and falling edges of the EFM signal are not detected such that the hold signal generator 543 may generate the EFM signal by detecting one or more edges of the EFM signal when the second sum signal SUM2 has a value greater than the desired voltage level Vth.

In example embodiments, the peaks of the signals shown in FIG. 7 may be more precisely detected by adjusting gains of the signals.

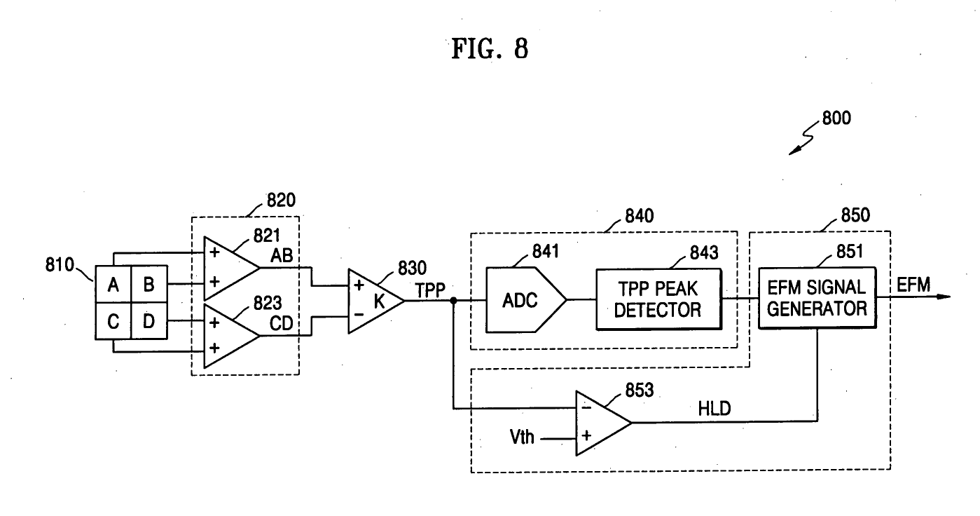

FIG. 8 is a block diagram illustrating an apparatus for generating a modulation signal, for example, an EFM signal, according to another example embodiment of the present invention. Referring to FIG. 8, the apparatus 800 for generating the EFM signal may include a light detector 810, an adder 820, a TPP signal generator 830, a TPP peak detector 840, and/or an EFM signal generator 850. Functions of the light detector 810, the adder 820, and the TPP signal generator 830 may be the same as that of the TPP signal generator 310 shown in FIG. 3.

The TPP peak detector 840 may detect peaks of a TPP signal in response to a digitally converted value of the TPP signal. The TPP peak detector 840 may include an analogue-digital converter 841 and a TPP peak determiner 843. The analogue-digital converter 841 converts the TPP signal into a digital signal.

In response to the digitally converted TPP signal, the TPP peak determiner 843 may determine points where an increasing value of the digitally converted TPP signal is changed to a decreasing value or a decreasing value is changed to an increasing value as peaks of the TPP signal.

For example, the analogue-digital converter 841 may sample the TPP signal and convert the sampled TPP signal into a digital TPP signal. The TPP peak determiner 843 may determine a point where an increasing value of the digitally converted TPP signal is changed to a decreasing value as a first peak of the TPP signal and a point where a decreasing value is changed to an increasing value as a second peak of the TPP signal.

In example embodiments, because the TPP signal is converted into a digital TPP signal to detect the first and second peaks of the TPP signal, the analogue-digital conversion may be performed at higher speed.

The EFM signal generator 850 may include a hold signal generator 853 and an EFM signal generator 851. The hold signal generator 853 may generate a hold signal HLD for controlling a period while the EFM signal is maintained at a desired level in response to the difference between the TPP signal and the given reference voltage Vth. The hold signal HLD does not change edges of the EFM signal regarding the TPP signal having a value less than that of the given reference voltage Vth.

In example embodiments, because the edges of the EFM signal are changed regarding the TPP signal higher than a given voltage level, the EFM signal may be generated more stably.

The EFM signal generator 851 may generate the EFM signal in response to the peaks of the TPP signal and the hold signal HLD. The EFM signal generator 851 may determine the first and second peaks of the TPP signal as first and second edges of the EFM signal, respectively.

The EFM signal generator 851 may maintain the EFM signal at a desired first level after the first edge and at a desired second level after the second edge, in response to the hold signal HLD to generate the EFM signal.

The apparatus 800 for generating the EFM signal may convert the TPP signal into a digital TPP signal to detect the first and second peaks of the TPP signal. The apparatus 800 for generating the EFM signal may be more easily realized.

Because the apparatus 800 for generating the EFM signal converts the TPP signal into a digital TPP signal to detect the first and second peaks of the TPP signal, the analogue-digital conversion must be performed at higher speed.

In other example embodiments of the present invention, a signal for delaying the TPP signal is used.

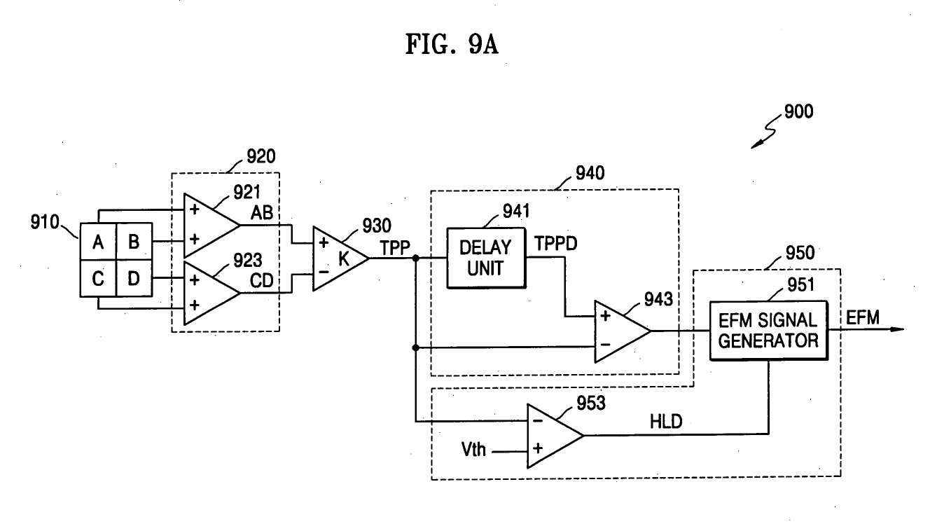

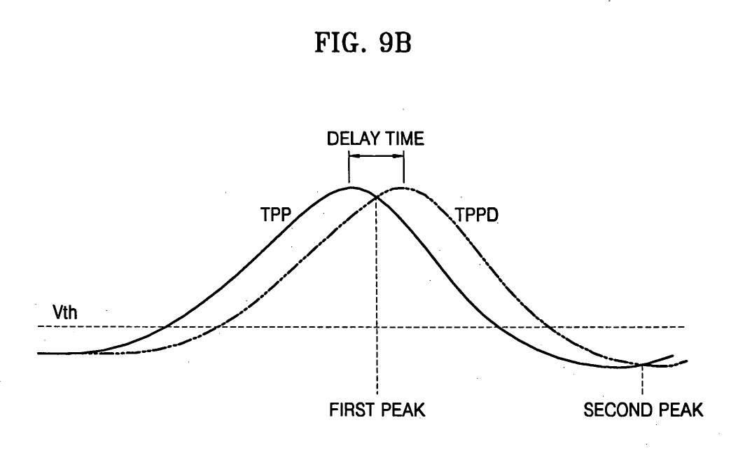

FIG. 9A is a block diagram illustrating an apparatus for generating an EFM signal according to an example embodiment of the present invention. Referring to FIG. 9A, the apparatus for generating the EFM signal 900 may include TPP signal generators 901 through 930, a TPP peak detector 940, and/or an EFM signal generator 950.

The TPP peak detector 940 may detect peaks of a TPP signal in response to a value of a delayed TPP signal. The TPP peak detector 940 may include a delay unit 941 and a TPP peak determiner 943. The delay unit 941 may delay the TPP signal. The delay unit 941 may delay the TPP signal depending on the speed of an optical disc, etc.

The TPP peak determiner 943 may determine peaks of the TPP signal in response to the difference between the delayed TPP signal TPPD and the TPP signal. The operation of the TPP peak determiner 943 will now be in detail described with reference to FIG. 9B.

FIG. 9B is a graph for comparing the TPP signal and the TPPD signal. Referring to FIG. 9B, the TPP signal is greater than the TPPD signal while rising from a second peak to a first peak and smaller than the TPPD signal while falling from the first peak to the second peak.

The TPP peak determiner 943 may determine a point where the TPP signal greater than the TPPD signal is changed to be smaller than the TPPD signal as the first peak of the TPP signal and a point where the TPP signal smaller than the TPPD signal is changed to be greater than the TPPD signal as the second peak of the TPP signal.

The EFM signal generator 950 may include a hold signal generator 953 and an EFM signal generator 951. The hold signal generator 953 may generate a hold signal HLD for controlling a period while the EFM signal is maintained with desired levels in response to the difference between the TPP signal and the given reference voltage Vth. The hold signal HLD does not change edges of the EFM signal regarding the TPP signal having a value less than that of the given reference voltage Vth.

In example embodiments, because the edges of the EFM signal are changed regarding the TPP signal higher than a given voltage level, the EFM signal may be generated more stably.

The EFM signal generator 951 may generate the EFM signal in response to the peaks of the TPP signal and the hold signal HLD. The EFM signal generator 951 may determine the first and second peaks of the TPP signal as first and second edges of the EFM signal.

The EFM signal generator 951 may maintain the EFM signal at a desired first level after the first edge and at a desired second level after the second edge in response to the hold signal HLD to generate the EFM signal.

The apparatus 900 for generating the EFM signal may detect the first and second peaks of the TPP signal in response to the difference between the TPPD signal and the TPP signal without performing a high-speed analogue-digital conversion.

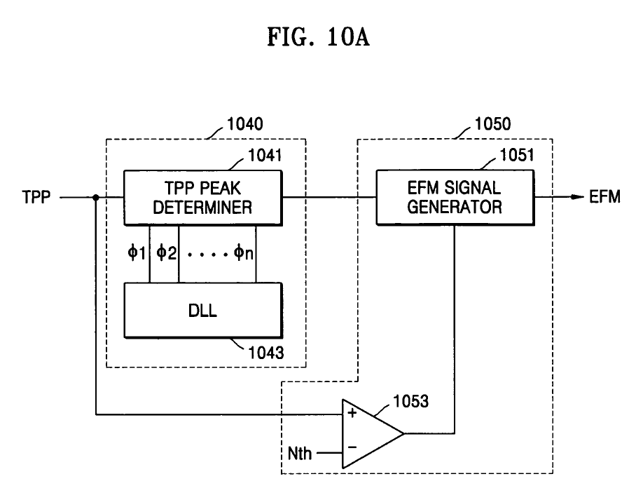

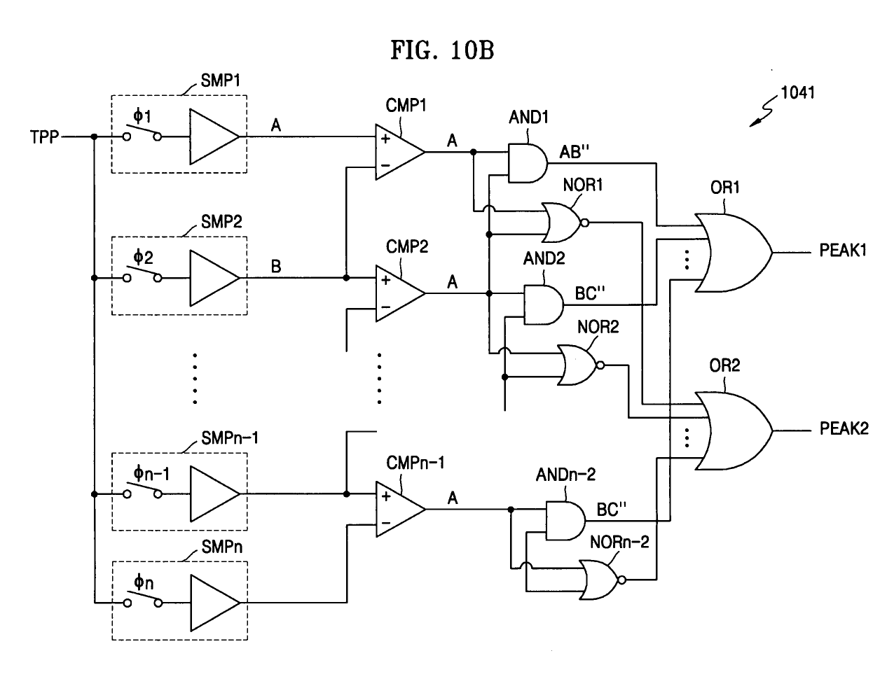

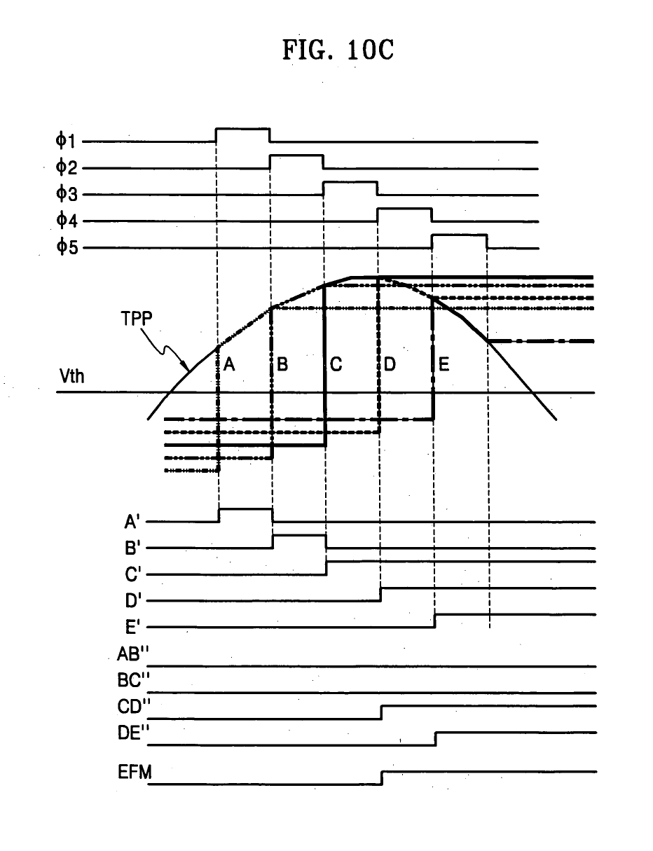

FIG. 10A is a block diagram illustrating an apparatus for generating an EFM signal according to an example embodiment of the present invention. Referring to FIG. 10A, the apparatus for generating the EFM signal may include a TPP signal generator (not shown), a TPP peak detector 1040, and/or an EFM signal generator 1050. The TPP signal generator may be the same as the TPP signal generator 910 through 930 shown in FIG. 9A, and thus is not illustrated in FIG. 10A.

The TPP peak detector 1040 may detect a TPP signal and peaks of the TPP signal in response to a plurality of clock signals φ1 through φn generated by a delayed locked loop (DLL) 1043. The TPP peak detector 1040 may include the DLL 1043 and the TPP peak determiner 1041.

The DLL 1043 may generate the plurality of clock signals φ1 through φn having a desired phase difference. The DLL 1043 may multiply a system clock used in an optical disc system (not shown) and generate the plurality of clock signals φ1 through φn having the desired phase difference. The number of clock signals generated in the DLL 1043 and the phase difference thereof may be determined according to the speed of an optical disc.

The TPP peak determiner 1041 may sample TPP signals using the plurality of clock signals φ1 through φn and determine peaks of TPP signals in response to differences between the sampled TPP signals. The operation of the TPP peak determiner 1041 will be now described with reference to FIGS. 10B and 10C.

FIG. 10B is a block diagram illustrating the TPP peak determiner shown in FIG. 10A and FIG. 10C is an example timing diagram illustrating signals in the TPP peak determiner.

The TPP peak determiner 1041 may include a plurality of sampling units SMP1 through SMPn, a plurality of comparators CMP1 through CMPn−1, first peak determiners AND1 through ANDn−2 and OR1, and/or second peak determiners NOR1 through NORn−2 and OR2.

The plurality of sampling units SMP1 through SMPn may sequentially sample TPP signals using the plurality of clock signals. The sampled TPP signals A, B, C, . . . are illustrated in FIG. 10C. If a clock period is T and the DLL 1043 generates n number of clock signals, the TPP signals are sampled at a period of T/n.

The plurality of comparators CMP1 through CMPn−1 may compare the sampled TPP signals A, B, C, . . . and output differences therebetween. If the differences are negative, the plurality of comparators CMP1 through CMPn−1 may output values of a first level (a low level) as differences A′, B′, C′, . . . . If the differences are positive, the plurality of comparators CMP1 through CMPn−1 may output values of a second level (a high level) as the differences A′, B′, C′, . . . .

Referring to FIG. 10C, while a TPP signal rises toward a first peak PEAK1, the output A′ and B′ of the comparators CMP1 through CMPn−1 is at the second level in the period of the clock signals φ1 and φ2, and the output A′ and B′ of the comparators CMP1 through CMPn−1 is at the first level in a period excluding the clock signals φ1 and φ2. When the TPP signal falls from the first peak PEAK1 (including the first peak PEAK1), the output C′, D′, E′ of the comparators CMP1 through CMPn−1 is at the second level.

When the TPP signal falls toward a second peak PEAK2, the output of the comparators CMP1 through CMPn−1 is at the first level in the period of the clock signals and at the second level in a period excluding the clock signals.

Therefore, the first peak determiners AND1 through ANDn−2 and OR1 may determine a point where the differences A′, B′, C′, D′, E′, . . . between the sampled TPP signals begin maintaining at the second level as the first peak PEAK1 of the TPP signal. Similarly, the second peak determiners NOR1 through NORn−2 and OR2 may determine a point where the differences A′, B′, C′, D′, E′, . . . between the sampled TPP signals begin maintaining at the first level as the second peak PEAK2 of the TPP signal.

The first peak determiners AND1 through ANDn−2 and OR1 may include a plurality of AND operators AND1 through ANDn−2 and a first OR operator. The plurality of AND operators AND1 through ANDn−2 may detect the point where the differences A′, B′, C′, D′, E′, . . . between the sampled TPP signals has the second level. That is, the plurality of AND gates AND1 through ANDn−2 AND may determine the differences A′, B′, C′, D′, E′, . . . between the sampled TPP signals.

As shown in FIG. 10C, the plurality of AND operators AND1 through ANDn−2 may output AB″ and BC″ at the first level regarding the differences A′ and B′ which no longer have the second level. The plurality of AND gates AND1 through ANDn−2 may output CD″ and DE″ at the second level regarding the differences C′, D′, and E′ which still have the second level.

For example, a sampling point (a boundary between C and D) corresponding to the AND gate AND3 which first has an output value of the second level among the AND gates AND1 through ANDn−2 may be determined as the first peak PEAK1 of the TPP signal.

The first OR operator OR1 may OR the output of the plurality of AND operators AND1 through ANDn−2. As shown in FIG. 10C, the output of the first OR operator OR1 has a rising edge at the sampling point determined as the first peak PEAK1 of the TPP signal.

The second peak determiners NOR1 through NORn−2 and OR2 1041A comprise a plurality of inversion OR operators NOR1 through NORn−2 and a second OR operator OR2. The plurality of inversion OR operators NOR1 through NORn−2 inversion OR operates the differences between the sampled TPP signals and detects the point where the differences between the sampled TPP signals have the first level.

The output of the plurality of inversion OR operators NOR1 through NORn−2 has the first level regarding the differences which no longer have the second level. The output of the plurality of inversion OR operators NOR1 through NORn−2 has the second level regarding the differences which still have the first level.

For example, a sampling point corresponding to an AND gate which first has an output value of the second level among the outputs of the inversion OR operators NOR1 through NORn−2 may be determined as the second peak PEAK2 of the TPP signal.

The second OR gate operator OR2 may OR the output of the plurality of inversion OR operators NOR1 through NORn−2 and output the second peak PEAK2.

Referring to FIG. 10A, the EFM signal generator 1050 may include a hold signal generator 1053 and an EFM signal generator 1051. The operations of the hold signal generator 1053 and the EFM signal generator 1051 may be the same as those of the hold signal generator 953 and the EFM signal generator 951 shown in FIG. 9A.

As described above, the apparatus 1000 for generating the EFM signal may detect the peaks of the TPP signal in response to the differences between the TPP signals sampled by the plurality of clock signals generated in the DLL 1043. For example, the apparatus 1000 for generating the EFM signal may detect the TPP signal without converting the TPP signal into a digital signal at high speed.

The plurality of clock signals generated in the DLL 1043 may be overlapped one another, causing a glitch. Therefore, odd clock signals or even clock signals of the plurality of clock signals may be used to detect the peaks of the TPP signal, which may result in removing the glitch caused by the overlapped clock signals and increasing stability of the apparatus for generating the EFM signal.

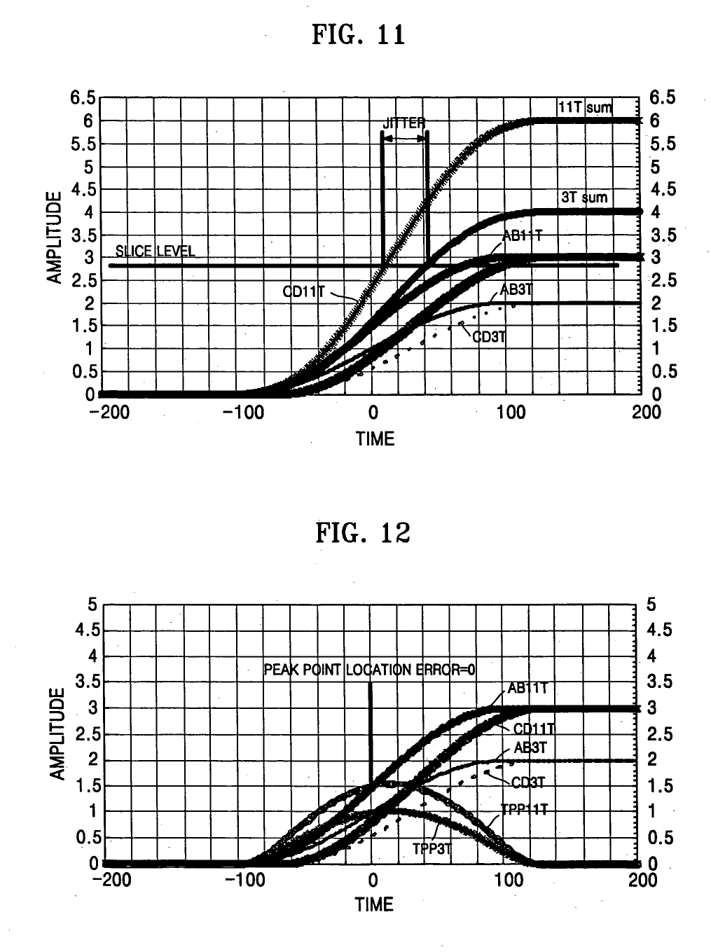

FIG. 11 is an example graph of variations in sum signals according to the length of marks in the TPP signal generator. Referring to FIG. 11, AB3T is a first sum signal in a mark having a time length of 3T and CD3T is a second sum signal in the mark having the time length of 3T. AB3T and the CD3T are delayed by a given time.

Similarly, AB11T is a first sum signal in a mark having a time length of 11T and CD11T is a second sum signal in the mark having the time length of 11T. AB11T and the CD11T are also delayed by a given time.

3TSUM is a positive sum signal of light reflected on the mark having the time length of 3T in combination with AB3T and CD3T. 11TSUM is a positive sum signal of light reflected on the mark having a time length of 11T in combination with AB11T and CD11T.

The conventional apparatus for generating the EFM signal slices 3TSUM and 11TSUM shown in FIG. 11 with each of desired slice levels to generate the EFM signal. However, as shown in FIG. 11, when 3TSUM and the 11TSUM are sliced with the same slice level, an asymmetry between 3TSUM and the 11TSUM causes jitter, and fails to generate an EFM signal.

FIG. 12 is an example graph for comparing TPP signals and sum signals according to the length of marks in a TPP signal generator. Referring to FIG. 12, TPP3T is the TPP signal in a mark having a time length of 3T and TPP11T is the TPP signal in the mark having the time length of 11T.

When marks have lengths of 3T and 11T, an error caused by a jitter does not occur at peaks of the TPP signals. Fr example, when the peaks of the TPP signals are determined as edges of the EFM signal, the EFM signal may be more accurately generated without jitter caused by asymmetry.

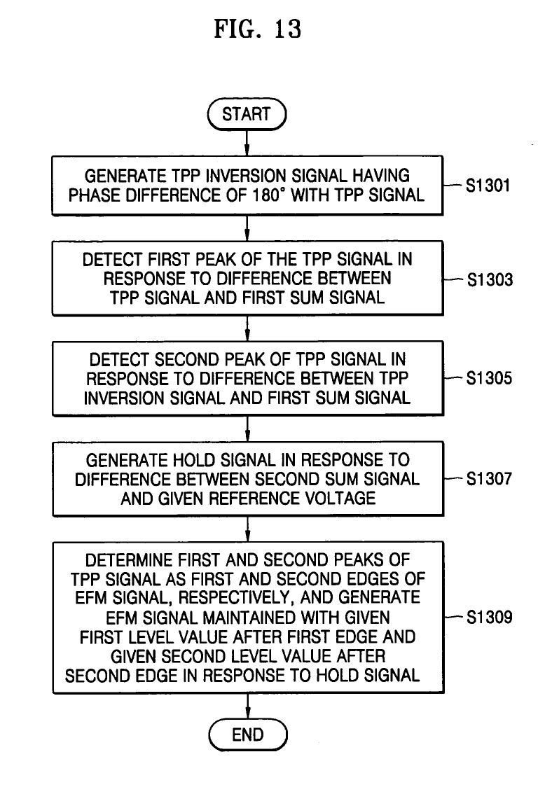

FIG. 13 is a flowchart of a method of generating an EFM signal according to an example embodiment of the present invention. The method may generate the EFM signal in response to a TPP signal generated by light reflected from an optical disc. For example, the method may detect peaks of the TPP signal, determine the detected peaks as edges of the EFM signal, and generate the EFM signal.

Referring to FIG. 13, to detect the peaks of the TPP signal, a TPP inversion signal TPP− having a phase difference of 180° with respect to the TPP signal may be generated after the TPP signal is generated (Operation S1301).

A first peak of the TPP signal may be a point where the TPP signal greater than a first sum signal SUM1 is changed to be smaller than the first sum signal SUM1. A second peak of the TPP signal may be a point where the TPP inversion signal TPP− smaller than the first sum signal SUM1 is changed to be greater than the first sum signal SUM1.

After the TPP inversion signal TPP− is generated, the first peak of the TPP signal may be detected in response to the difference between the TPP signal and the first sum signal SUM1 (Operation S1303). The second peak of the TPP signal may be detected in response to the difference between the TPP inversion signal TPP− and the first sum signal SUM1 (Operation S1305).

The first and second peaks of the TPP signal may be detected in response to the difference between the TPP signal and the TPP inversion signal TPP−, and a total sum signal ABCD_SUM.

The TPP inversion signal TPP− may be generated in response to the difference between a second sum signal SUM2 and the first sum signal SUM1.

After the peaks of the TPP signal are detected, the detected peaks of the TPP signal may be determined as edges of the EFM signal to generate a hold signal HLD before the EFM signal is generated (Operation S1307). For example, the hold signal HLD for controlling a period when the EFM signal is maintained at desired levels may be generated in response to the difference between the second sum signal SUM2 and a given reference voltage Vth.

After the hold signal HLD is generated, the EFM signal that is maintained at the given level after the edges, may be generated in response to the peaks of the TPP signal and the hold signal HLD.

For example, the first and the second peaks of the TPP signal may be determined as first and second edges of the EFM signal, respectively, to generate the EFM signal that is maintained with a desired first level after the first edge and a desired second level after the second edge in response to the hold signal HLD (Operation S1309).

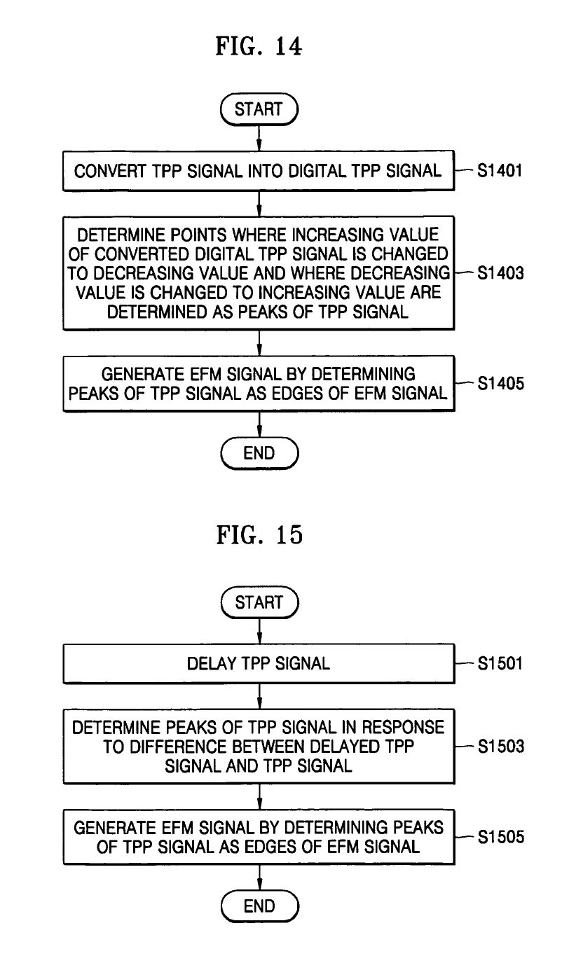

FIG. 14 is a flowchart of a method of generating an EFM signal according to another example embodiment of the present invention. The method may convert a TPP signal into a digital signal and detect peaks of the converted TPP signal, determine peaks of the detected TPP signal as edges of the EFM signal to generate the EFM signal.

Referring to FIG. 14, a TPP signal may be converted into a digital signal (Operation S1401). An increasing value of the converted digital TPP signal may be changed to a decreasing value or the decreasing value may be changed to the increasing value.

A point where the increasing value of the TPP signal is changed to the decreasing value is a first peak of the TPP signal and a point where the decreasing value is changed to the increasing value is a second peak of the TPP signal. Therefore, the points where the increasing value of the converted digital TPP signal is changed to the decreasing value and where the decreasing value is changed to the increasing value may be determined as the peaks of the TPP signal (Operation S1403).

The peaks of the TPP signal are boundaries between marks and non-marks of an optical disc, which are edges of the EFM signal. Therefore, the peaks of the TPP signal may be determined as the edges of the EFM signal to generate the EFM signal (Operation S1405).

FIG. 15 is a flowchart of a method of generating an EFM signal according to another example embodiment of the present invention. The method may detect peaks of a TPP signal in response to the difference between the TPP signal and a signal that delays the TPP signal and determines the detected peaks of the TPP signal as edges of the EFM signal to generate the EFM signal.

Referring to FIG. 15, a TPP signal may be delayed to generate a delayed TPP signal TPPD (Operation S1501). A point where the TPP signal greater than the delayed TPP signal TPPD is changed to be smaller than the delayed TPP signal TPPD is a first peak of the TPP signal. A point where the TPP signal smaller than the delayed TPP signal TPPD is changed to be greater than the delayed TPP signal TPPD is a second peak of the TPP signal.

Therefore, the peaks of the TPP signal may be determined in response to the difference between the delayed TPP signal TPPD and the TPP signal (Operation S1503). For example, the point where the TPP signal greater than the delayed TPP signal TPPD is changed to be smaller than the delayed TPP signal TPPD is determined as the first peak of the TPP signal. The point where the TPP signal smaller than the delayed TPP signal TPPD is changed to be greater than the delayed TPP signal TPPD is the second peak of the TPP signal.

The peaks of the TPP signal are boundaries between marks and non-marks of an optical disc, which are edges of the EFM signal. Therefore, the peaks of the TPP signal may be determined as the edges of the EFM signal to generate the EFM signal (Operation S1505).

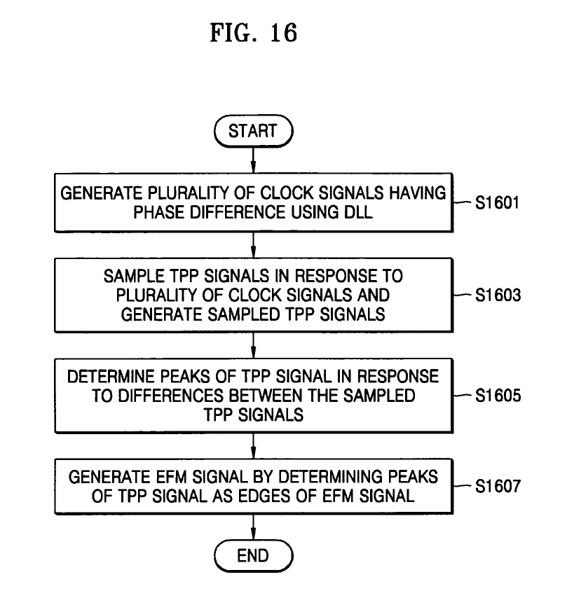

FIG. 16 is a flowchart of a method of generating an EFM signal according to another example embodiment of the present invention. The method may detect peaks of a TPP signal in response to a plurality of clock signals having a phase difference with the TPP signal and the detected peaks of the TPP signal are determined as edges of the EFM signal to generate the EFM signal.

Referring to FIG. 16, a plurality of clock signals having a phase difference may be generated in response to a system clock used in an optical disc system (Operation S1601). The plurality of clock signals may be generated using a DLL.

TPP signals may be sampled in response to the plurality of clock signals (Operation S1603). TPP signals may be sequentially sampled in response to the plurality of clock signals and the sampled TPP signals may have the same phase difference.

Differences between the sampled TPP signals may be calculated and peaks of the TPP signal may be detected in response to the calculated differences between the sampled TPP signals (Operation S1605). Referring to FIG. 10C, while the TPP signal rises toward the first peak, the differences A′ and B′ is at a second level in the period of the clock signals φ1 and φ2 and at the first level in a period excluding the clock signals φ1 and φ2. When the TPP signal falls from the first peak (including the first peak), the differences C′, D′, E′ is maintained at the second level.

For example, a point where the differences A′, B′, C′, D′, and E′ of the sampled TPP signals have the second level is determined as the first peak of the TPP signal. Similarly, a point where the differences A′, B′, C′, D′, and E′ of the sampled TPP signals have the first level is determined as the second peak of the TPP signal.

The peaks of the TPP signal are boundaries between marks and non-marks of an optical disc, which are edges of the EFM signal. Therefore, the peaks of the TPP signal may be determined as the edges of the EFM signal to generate the EFM signal (Operation S1607).

In example embodiments, an apparatus and method for generating an EFM signal may determine peaks of a TPP signal as edges of the EFM signal to generate the EFM signal, thereby reducing or minimizing timing jitter caused by an asymmetry of marks or pits.

In example embodiments, an apparatus and method for generating an EFM signal can accurately generate the EFM signal without an AGC, an EQ, and/or a partial response maximum likelihood (PRML), etc. which may be used in a conventional art.

In example embodiments, an apparatus and method for generating an EFM signal can reduce or minimize the timing jitter caused by the asymmetry of marks or pits, increase readability of an optical disc, and/or reduce circuit area and power consumption.

Although example embodiments of the present invention have been described in conjunction with an EFM signal, the teachings of example embodiments of the present invention may be used with any other modulation signal.

While the present invention has been particularly shown and described with reference to an example embodiment thereof, it will be understood by those of ordinary skill in the art that various changes in form and details may be made therein without departing from the spirit and scope of the invention as defined by the appended claims and their equivalents.

What is claimed is:

1. An apparatus for generating a modulation signal in response to a tangential push-pull (TPP) signal generated by light reflected from an optical disc, the apparatus comprising:
a TPP peak detector detecting peaks of the TPP signal; and
a signal generator generating the modulation signal by determining the detected peaks of the TPP signal as edges of the modulation signal.

2. The apparatus of claim 1, wherein the TPP peak detector detects the peaks of the TPP signal in response to a value of an analogue-digital converted TPP signal.

3. The apparatus of claim 1, wherein the TPP peak detector detects the peaks of the TPP signal in response to a value of a delayed TPP signal.

4. The apparatus of claim 1, wherein the TPP peak detector detects the peaks of the TPP signal in response to a TPP signal and a plurality of clock signals having a given phase difference with one another.

5. The apparatus of claim 1, wherein the TPP peak detector detects the peaks of the TPP signal in response to the TPP signal and a TPP inversion signal having a phase difference of 180° with respect to one another.

6. The apparatus of claim 5, wherein the TPP inversion signal is generated in response to the difference between a first sum signal indicating a sum of the amount of preceding reflected light to the track forward direction and a second sum signal indicating a sum of the amount of following reflected light to the track forward direction.

7. The apparatus of claim 5, wherein the TPP peak detector comprises:
a first peak detector detecting a first peak of the TPP signal in response to the difference between the TPP signal and the first sum signal indicating a sum of the amount of the preceding reflected light to the track forward direction; and
a second peak detector detecting a second peak of the TPP signal in response to the difference between the TPP inversion signal and the first sum signal.

8. The apparatus of claim 5, wherein the TPP peak detector comprises:
a first peak detector detecting a first peak of the TPP signal in response to the difference between the TPP signal and a total sum signal indicating a total sum of the amount of reflected light; and
a second peak detector detecting a second peak of the TPP signal in response to the difference between the TPP inversion signal and the total sum signal.

9. The apparatus of claim 5, wherein the signal generator comprises:
a hold signal generator generating a hold signal for controlling a period when the modulation signal is maintained at a given level in response to the difference between the second sum signal indicating a sum of the amount of the following reflected light to the track forward direction and a given reference voltage; and
a signal generator unit generating the modulation signal maintained at the given level after the edges in response to the peaks of the TPP signal and the hold signal.

10. The apparatus of claim 9, wherein the signal generator determines the first and second peaks of the TPP signal as first and second edges of the modulation signal, respectively, and generates the modulation signal maintained at a given first level after the first edge and a given second level after the second edge in response to the hold signal.

11. The apparatus of claim 5, wherein gains of the TPP signal and the TPP inversion signal are adjusted according to the speed of the optical disc.

12. The apparatus of claim 1, further comprising:
an analogue-digital converter converting the TPP signal into a digital TPP signal.

13. The apparatus of claim 12, wherein the TPP peak determiner determines a point where the increasing value is changed to the decreasing value as a first peak of the TPP signal and a point where the decreasing value is changed to the increasing value as a second peak of the TPP signal.

14. The apparatus of claim 12, wherein the signal generator comprises:
a hold signal generator generating a hold signal for controlling a period when the modulation signal is maintained at a given level in response to the TPP signal; and
a signal generator unit generating the modulation signal maintained at the given level after the edges in response to the peaks of the TPP signal and the hold signal.

15. The apparatus of claim 14, wherein the signal generator determines the first and second peaks of the TPP signal as first and second edges of the modulation signal, respectively, and generates the modulation signal maintained with a given first level after the first edge and a given second level after the second edge in response to the hold signal.

16. The apparatus of claim 12, wherein a gain of the TPP signal is adjusted according to the speed of the optical disc.

17. The apparatus of claim 1, further comprising:
a delay unit delaying the TPP signal, the TPP peak determiner determining peaks of the TPP signal in response to the difference between the delayed TPP signal and the TPP signal.

18. The apparatus of claim 17, wherein the TPP peak determiner determines a point where the TPP signal greater than the delayed TPP signal is changed to be smaller than the delayed TPP signal as a first peak of the TPP signal and a point where the TPP signal smaller than the delayed TPP signal is changed to be greater than the delayed TPP signal as a second peak of the TPP signal.

19. The apparatus of claim 17, wherein the signal generator comprises:
a hold signal generator generating a hold signal for controlling a period when the signal is maintained at a given level in response to the TPP signal; and
a signal generator unit generating the modulation signal maintained at the given level after the edges in response to the peaks of the TPP signal and the hold signal.

20. The apparatus of claim 19, wherein the signal generator determines the first and second peaks of the TPP signal as first and second edges of the modulation signal, respectively, and generates the modulation signal maintained with a given first level after the first edge and a given second level after the second edge in response to the hold signal.

21. The apparatus of claim 17, wherein a gain of the TPP signal is adjusted according to the speed of the optical disc.

22. The apparatus of claim 1, further comprising:
a delayed locked loop (DLL) generating a plurality of clock signals having a given phase difference, the TPP peak determiner sequentially sampling TPP signals in response to the plurality of clock signals and determining peaks of the TPP signal in response to differences between the sequentially sampled TPP signals.

23. The apparatus of claim 22, wherein the TPP peak determiner comprises:
a plurality of sampling units sequentially sampling TPP signals in response to the plurality of clock signals;
a plurality of comparators comparing the sequentially sampled TPP signals and outputting differences therebetween;
a first peak determiner determining a point where a difference is maintained at a second level as a first peak of the TPP signal in response to the output differences; and
a second peak determiner determining a point where a difference is maintained at a first level as a second peak of the TPP signal in response to the output differences.

24. The apparatus of claim 23, wherein the first peak determiner comprises:
a plurality of AND operators AND-operating the differences; and
a first OR operator OR-operating outputs of the plurality of AND operators.

25. The apparatus of claim 23, wherein the first peak determiner comprises:
a plurality of NOR operators NOR-operating the differences; and
a second OR operator OR-operating outputs of the plurality of NOR operators.

26. The apparatus of claim 22, wherein the signal generator comprises:
a hold signal generator generating a hold signal for controlling a period when the modulation signal is maintained at a given level in response to the TPP signal; and
a signal generator unit generating the modulation signal maintained at the given level after the edges in response to the peaks of the TPP signal and the hold signal.

27. The apparatus of claim 26, wherein the signal generator determines the first and second peaks of the TPP signal as first and second edges of the modulation signal, respectively, and generates the modulation signal maintained at a given first level after the first edge and a given second level after the second edge in response to the hold signal.

28. The apparatus of claim 22, wherein a gain of the TPP signal is adjusted according to the speed of the optical disc and the given phase difference is determined according to the speed of the optical disc.

29. The apparatus of claim 1, wherein the modulation signal is an eight-to-fourteen modulation (EFM) signal and the signal generator is an EFM signal generator.

30. A method of generating a modulation signal in response to a TPP signal generated by light reflected from an optical disc, the method comprising:
detecting peaks of the TPP signal; and
generating the modulation signal by determining the detected peaks of the TPP signal as edges of the modulation signal.

31. The method of claim 30, wherein detecting of the peaks of the TPP signal comprises:
generating a TPP inversion signal having a phase difference of 180° with respect to the TPP signal;
detecting a first peak of the TPP signal in response to the difference between the TPP signal and a first sum signal indicating a sum of the amount of preceding reflected light to the track forward direction; and
detecting a second peak of the TPP signal in response to the difference between the TPP inversion signal and the first sum signal.

32. The method of claim 30, wherein the detecting of the peaks of the TPP signal comprises:
generating a TPP inversion signal having a phase difference of 180° with respect to the TPP signal;
detecting a first peak of the TPP signal in response to the difference between the TPP signal and a total sum signal indicating a total sum of the amount of reflected light; and
detecting a second peak of the TPP signal in response to the difference between the TPP inversion signal and the total sum signal.

33. The method of claim 31, wherein the TPP inversion signal is generated in response to the difference between a first sum signal indicating a sum of the amount of the preceding reflected light to the track forward direction and a second sum signal indicating a sum of the amount of following reflected light to the track forward direction.

34. The method of claim 30, wherein the generating of the modulation signal comprises:
generating a hold signal for controlling a period when the modulation signal is maintained at a given level in response to the difference between the second sum signal indicating a sum of the amount of reflected light that moves backward the track of the optical disc and a given reference voltage; and
generating the modulation signal maintained at the given level after the edges in response to the peaks of the TPP signal and the hold signal.

35. The method of claim 34, wherein generating the modulation signal determines the first and second peaks of the TPP signal as first and second edges of the modulation signal, respectively, and generates the modulation signal maintained at a given first level after the first edge and a given second level after the second edge in response to the hold signal.

36. The method of claim 30, wherein detecting peaks of the TPP signal comprises:
converting the TPP signal into a digital TPP signal; and
determining points where an increasing value of the converted TPP signal is changed to a decreasing value and the decreasing value is changed to the increasing value as peaks of the TPP signal in response to the converted TPP signal.

37. The method of claim 30, wherein detecting peaks of the TPP signal comprises:
delaying the TPP signal; and
determining peaks of the TPP signal in response to the difference between the delayed TPP signal and the TPP signal.

38. The method of claim 30, wherein detecting peaks of the TPP signal comprises:
generating a plurality of clock signals having a given phase difference;
sequentially sampling TPP signals in response to the plurality of clock signals; and
determining peaks of the TPP signal in response to differences between the sequentially sampled TPP signals.

39. The method of claim 30, wherein the modulation signal is an eight-to-fourteen modulation (EFM) signal.
